(19) United States
(12) Patent Application Publication
(10) Pub. No.: US 2016/0034933 A1
(43) Pub. Date: Feb. 4, 2016

(54) COMMUNITY MARKETING SYSTEM AND THE OPERATION METHOD THEREOF

(71) Applicant: Chia-Hao CHANG, Taipei (TW)

(72) Inventor: Chia-Hao CHANG, Taipei (TW)

(21) Appl. No.: 14/810,615

(22) Filed: Jul. 28, 2015

(30) Foreign Application Priority Data
Jul. 29, 2014 (TW) 103125790

(51) Int. Cl. G06Q 30/02

(52) U.S. Cl. CPC G06Q 30/0211

(57) ABSTRACT

A community marketing system is disclosed in the present invention, the present invention comprises the price computing apparatus, the coupon apparatus, the share-feedback apparatus, and the direct feedback apparatus. The present invention also discloses that the operation method for the community marketing system, firstly processing the categories pricing step, and then transmitting an order from the categories pricing to the coupon apparatus, the share-feedback apparatus, and the direct feedback apparatus, and processing the calculation for the share-feedback step, and the direct feedback step.

### BACKGROUND OF THE INVENTION

1. Field of the Invention

The present invention relates to a marketing system, particularly to a community marketing system having a coupon (i.e., special offers) apparatus.

2. Description of the Prior Art

The Marketing System is usually interpreted as a business to create value for the customers, and can exchange all kinds of resources of the customers, and to enable the enterprises to obtain the sales revenue, and the business system of return on investment. As well known, the marketing system includes three systems: production system, brand system, and sales service system. In order to meet customer demands, the enterprise system can provide the specific utility and the value for the customers, not only including tangible products, but also including intangible services to meet the value which is pursued by the customers.

Most of the modern marketing system are Internet-based (Internet) marketing system, also is the basis for the enterprises to carry out the network marketing, mainly include the enterprise management information system which is based on the internal network (Intranet) established, the enterprise information systems, the internet marketing websites, and the business management staff is composed of four parts. Especially the website of the internet marketing is constructed by the enterprises, and there is the network marketing function for the website of the internet marketing, the website of the internet marketing can be connected to the internet website. On the one hand, the website of the internet marketing allows the customers (or suppliers) of the enterprises through the Internet to understand the enterprise information, and the website of the internet marketing can provide business transactions with the enterprises through the website; on the other hand, the website of the internet marketing can be connected to the market information, and the internal executive information system of the enterprises, and the internal management systems can organize the marketing management activities according to the market change.

Since compared to the conventional marketing system, the network marketing system is undergone great changes, the network marketing system of the enterprise should be based on the demands of the market for the network marketing system, particularly those belonging to the field of marketing process, need to construct a new network marketing organization, to change the marketing process, reorganizing and adjusting new community organization, to create a new marketing organization, and even more to be able to establish the marketing community, the more need to develop the new community marketing system.

### SUMMARY OF THE INVENTION

In view of the aspect, the present invention provides a community marketing system and the operation. method thereof, which can construct the new network marketing organization, in order to change the marketing procedure.

According to the above-mentioned, the present invention provides a community marketing system which comprises: a price computing apparatus, a coupon apparatus, a share-feedback apparatus, and a direct feedback apparatus. Wherein the price computing apparatus is connected to the coupon apparatus, the share-feedback apparatus, and the direct feedback apparatus. Wherein the share-feedback apparatus is connected to the coupon apparatus and the direct feedback apparatus. Wherein the direct feedback apparatus is connected to the share-feedback apparatus, and the coupon apparatus. Wherein the coupon apparatus is connected to the price computing apparatus, the share-feedback apparatus, and the direct feedback apparatus. The “coupon” system of the present invention, i.e., “coupon” comprises meaning of special offers, which is the wide and genetic name when the present invention is under operation, and when the present invention in the actual operation on the computer, the “coupon” system of the present invention can be presented as the “discount code (Code)” presentation, or might be “the coupon operating program” presented. Therefore “coupons” of the present invention can be a variety of computer code or presents various types of computer use in the computer program, subject to the notice, the present invention is not so limited.

The present invention provides an operation method for a community marketing system, when an order is entered, i.e., the step of inputting the order is started, next, processing the coupon-judgement step, and then processing the order-judgement step, and connecting the price-computing step, finally, in order to produce the order from the categories pricing step.

The result of the order from the categories pricing of the present invention will be transmitted to the coupon apparatus, the share-feedback apparatus, and the direct feedback apparatus. Therefore, the share-feedback apparatus will transmit the result of the order from the categories pricing of the present invention. When an order is entered into the share-feedback apparatus, if it is judged as the step of the personal-share-back, then processes the step of the coupon-proportion feedback. When an order is entered into the share-feedback apparatus, if it is judged as the step of the community-share-back, then processes the step of the direct feedback, or processes the step of the indirect feedback. When an order is entered into the direct feedback apparatus, if it is judged and calculated by the step of the collaborative-back, then processes the step for calculating and decreasing the product-percentage according to the coupon-proportion.

In an embodiment of the present invention, the present invention provides that an operation method for a community marketing system, which is belonged to a marketing procedure field, the present invention can construct the new network marketing organization, in order to change the marketing procedure.

Another purpose of the present invention is to provide that an operation method for a community marketing system, reorganize and adjust the new marketing organization, renew the new marketing organization, furthermore, enable to construct the new marketing community, in order to develop the new kind of friendly community marketing system.

### BRIEF DESCRIPTION OF THE DRAWINGS

FIG. 1 illustrates a community marketing system for an embodiment of the present invention;

FIG. 2 illustrates an operation method for a community marketing system for an embodiment of the present invention.

### DESCRIPTION OF THE PREFERRED EMBODIMENT

In the following description, the Figures will be used to describe the implementation way of the present invention. In the Figures, the same symbol represents the same component, and the size of component may be exaggerated for more clear description.

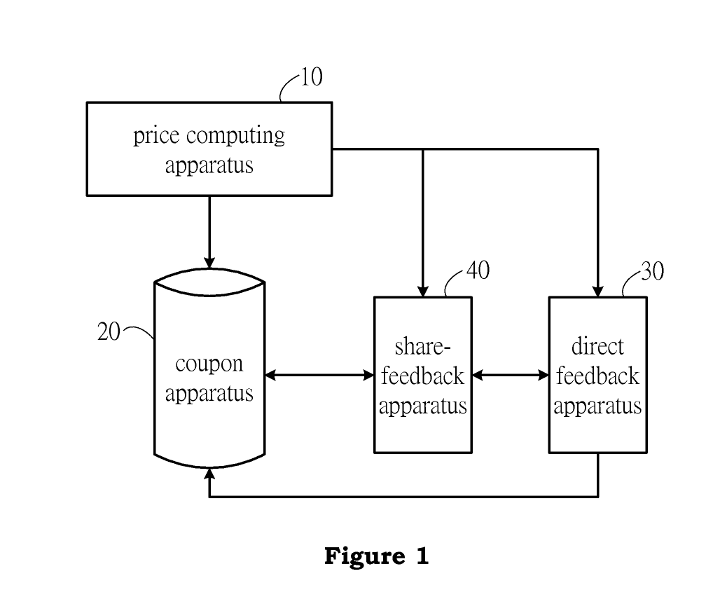

Firstly, please refer to FIG. 1. FIG. 1 illustrates the present invention for a community marketing system, comprises a price computing apparatus 10, a coupon apparatus 20, a share-feedback apparatus 30, and a direct feedback apparatus 40. Wherein the price computing apparatus 10 owns a category-pricing function, the coupon apparatus 20 owns a coupon providing function, the share-feedback apparatus 30 owns a coupon calculation. function and a coupon classification for use function, and, the direct feedback apparatus 40 owns a progressive-distribution coupon function.

The “coupon” of the present invention, which is a sharing concept for discounting, using the coupon system such as adding a friendly community members can have a coupon, that is, when the friendly community members share “coupon” with other friends, the friendly community members having coupons will not reduce, but there multiply (for example, 1.5 times) increase and preferentially share feedback. The “coupon” system of the present invention, i.e., “coupon” comprises meaning of special offers, which is a wide and genetic name when the present invention is under operation, and when the present invention in the actual operation on the computer, the “coupon” system of the present invention can be presented as the “discount code (Code)” presentation, or might be “the coupon operating program” presented, therefore “coupons” of the present invention can be a variety of computer code or presents various types of computer use in the computer program, subject to the notice, the present invention is not so limited.

Firstly, in FIG. 1, wherein the price computing apparatus 10 is connected to the coupon apparatus 20, the share-feedback apparatus 30, and the direct feedback apparatus 40.

In FIG. 1, the share-feedback apparatus 30 is connected to the coupon apparatus 20, and the direct feedback apparatus 40.

Next in FIG. 1, wherein the direct feedback apparatus 40 is connected to the share-feedback apparatus 30, and the coupon apparatus 20.

FIG. 1 shows that the coupon apparatus 20 is connected to the price computing apparatus 10, the share-feedback apparatus 30, and the direct feedback apparatus 40.

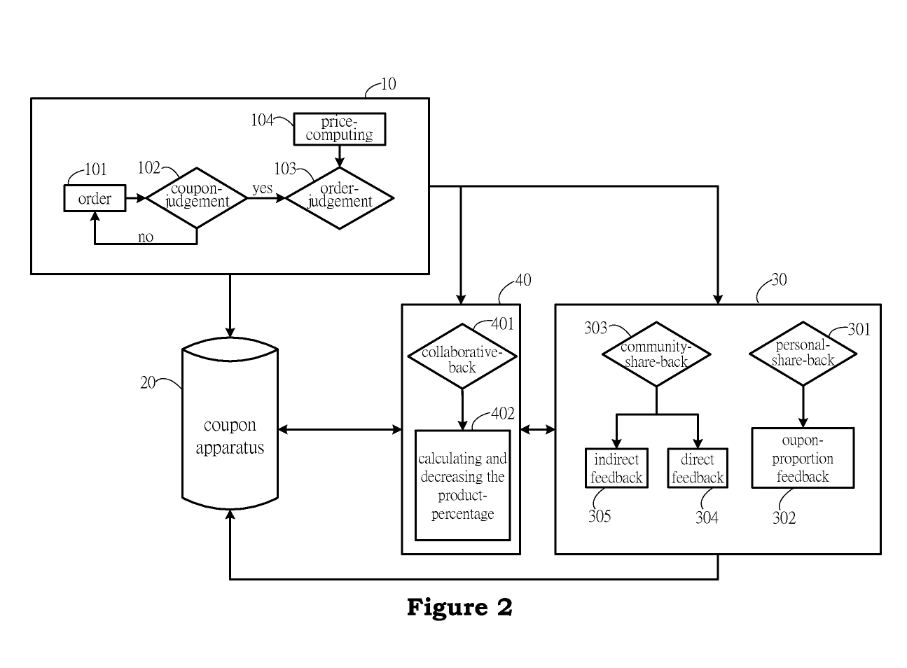

FIG. 2 shows that an operation method for a community marketing system of the present invention. Firstly, as the price computing apparatus 10 of FIG. 2, when an order is entered into the price computing apparatus 10, then inputting an order step 101 is started, next, processing a coupon-judgement step 102, and then processing an order-judgement step 103, and finally, connecting a price-computing step 104, in order to produce the result of the order from the categories pricing in the price computing apparatus 10. The result of the order from the categories pricing will be transmitted to the coupon apparatus 20, the share-feedback apparatus 30, and the direct feedback apparatus 40.

Next, as the share-feedback apparatus 30 of FIG. 2, transmitting the result of the order from the categories pricing to the share-feedback apparatus 30, wherein the share-feedback apparatus 30 processes the calculation of the personal-share-back 301, and processes the calculation of the community-share-back 303.

Still as the share-feedback apparatus 30 of FIG. 2, when an order is entered into the share-feedback apparatus 30, if it is judged as the step of the personal-share-back 301, then processes the step of the coupon-proportion feedback 302. Therefore, according to the result of the coupon-proportion feedback 302 by calculation, it will be transmitted to the coupon apparatus 20, then the coupon apparatus 20 will transmit the coupon to the direct feedback apparatus 40.

Still again, as the share-feedback apparatus 30 of FIG. 2, when an order is entered into the share-feedback apparatus 30, if it is judged as the step of the community-share-back 303, then processes the step of the direct feedback 304, or processes the step of the indirect feedback 305. Therefore, according to the result of the step from the direct feedback 304, or the result of the step from the indirect feedback 305 by calculation, it will be transmitted to the coupon apparatus 20.

As the direct feedback apparatus 40 of FIG. 2, when an order is entered into the direct feedback apparatus 40, if it is judged and calculated by the step of the collaborative-back 401, then processes the step for calculating and decreasing the product-percentage according to the coupon-proportion 402.

The present invention provides a community marketing system and the operation method thereof, which is belonged to a kind of special field for the marketing process, also, it can construct the new network marketing organization, in order to change the marketing procedure.

The present invention provides a community marketing system and the operation method thereof, it is able to reorganize and adjust the new marketing organization, renew the new marketing organization, furthermore, enable to construct the new marketing community, in order to develop the new kind of friendly community marketing system.

It is understood that various other modifications will be apparent to and can be readily made by those skilled in the art without departing from the scope and spirit of this invention. Accordingly, it is not intended that the scope of the claims appended here to be limited to the description as set forth herein, but rather that the claims be construed as encompassing all the features of patentable novelty that reside in the invention, including all features that would be treated as equivalents thereof by those skilled in the art to which this invention pertains.

What is claimed is:

1. A community marketing system, comprising:
a price computing apparatus, said price computing apparatus having a category-pricing function;
a coupon apparatus, said coupon apparatus having a coupon providing function;
a share-feedback apparatus, said share-feedback apparatus having a coupon calculation function and a coupon classification for use function;
a direct feedback apparatus, said direct feedback apparatus having a progressive-distribution coupon function,
wherein said price computing apparatus being connected to said coupon apparatus, said share-feedback apparatus, and said direct feedback apparatus, wherein said share-feedback apparatus being connected to said coupon apparatus and said direct feedback apparatus, wherein said direct feedback apparatus being connected to said share-feedback apparatus, and said coupon apparatus, wherein said coupon apparatus is connected to said price computing apparatus, said share-feedback apparatus, and said direct feedback apparatus.

2. An operation method for a community marketing system, comprising:
processing an categories pricing step, wherein transmitting an order from said categories pricing step to a coupon apparatus, a share-feedback apparatus, and a direct feedback apparatus;
using said share-feedback apparatus to calculate a personal-share-back step, when said order from said categories pricing step enters said share-feedback apparatus, processing said personal-share-back step; and
processing a coupon-proportion feedback step.

3. The method according to claim 2, wherein said processing an categories pricing step, comprising:
inputting an order step;
processing a coupon-judgement step;
processing an order-judgement step; and
connecting a price-computing in order to produce an order from a categories pricing step.

4. An operation method for a community marketing system, comprising:
processing an categories pricing step, transmitting an order from said categories pricing step to a coupon apparatus, share-feedback apparatus, and a direct feedback apparatus;
using said share-feedback apparatus to calculate a community-share-back step, when said order from said categories pricing step enters said share-feedback apparatus, processing said community-share-back step; and
processing a direct feedback step, or processing an indirect feedback step.

5. The method according to claim 4, wherein processing an categories pricing step comprises:
inputting an order step;
processing a coupon-judgement step;
processing an order-judgement step; and
connecting a price-computing in order to produce an order from a categories pricing step.

6. An operation method for a community marketing system, comprising:
processing an categories pricing step, transmitting an order from said categories pricing step to a coupon apparatus, a share-feedback apparatus, and a direct feedback apparatus;
using said direct feedback apparatus to calculate a collaborative-back step, when said order from said categories pricing step enters said direct feedback apparatus, processing said collaborative-back step; and
calculating and decreasing a product-percentage according to a coupon-proportion.

7. The method according to claim 6, wherein processing an categories pricing step comprises:
inputting an order step;
processing a coupon-judgement step;
processing an order-judgement step; and
connecting a price-computing in order to produce an order from a categories pricing step.
